(19) United States
(12) Patent Application Publication
(10) Pub. No.: US 2013/0341920 A1
(43) Pub. Date: Dec. 26, 2013

(54) SYSTEM FOR GENERATING ELECTRIC CURRENT WHICH IS PRODUCED BY THE FORCE OF INERTIAL MOVEMENT IN SLOT CARS OR THE LIKE AND THROUGH THE USE OF MAGNETIC LEVITATION

(71) Applicant: Carlos Antonio Carreño Vargas, Santiago (CL)

(72) Inventor: Carlos Antonio Carreño Vargas, Santiago (CL)

(21) Appl. No.: 14/003,800

(22) PCT Filed: Mar. 16, 2011
(86) PCT No.: PCT/CL2011/000018

§ 371 Date: Sep. 8, 2013

(51) Int. Cl. H02N 15/00

(52) U.S. Cl. CPC H02N 15/00
USPC 290/3

(57) ABSTRACT

System to generate electrical energy by magnetic levitation, using inertia propulsion force exerted by the railway carriages or similar, as used in entertaining games, characterized because system is formed with some alternators, which generate the current through the force of the rotational movement of the shafts connected to the transmission system of each of the wheels of the carriages, the alternators generates current, which is driven through power lines to a transformer provided with ground connections, through charcoal located at the wheels as a safety; generated current to transformer is driven by a high voltage line to a pantograph which allows to deliver the generated current to high voltage cables or stored in batteries for further use.

“System for generating electric current, produced by the force of inertia movement in railcars or similar and by using the magnetic levitation”.

### DESCRIPTION

System to generate electrical energy by magnetic levitation, using the propulsion of the force exerted by cars, as used in entertaining games. System to generate electrical energy by magnetic levitation, using the propulsion of the force exerted by cars, as used in entertaining games, which are uploaded on a ramp of about 35° and about 50 meters long, then are released and besides falling inertia, given two turns (360°) then up for a parallel ramp to same inclination, almost to the same starting height, more specifically, electric power can be obtained by replacing the wheels of the carriages for electric generators and through installation and use of electromagnetic systems to enable this system or carriage through a complete cycle and can be autonomously restart another, as these electromagnets allows facilitate moving of cars and improve propulsion while producing and storing electricity.

The magnetic levitation transport, Maglev or Juice; is a transportation system that includes suspension, guidance and vehicle propulsion, especially trains, using a large number of magnets for lift and propulsion, based on magnetic levitation.

This method has the advantage of being faster, quieter and smoother than mass transit systems on conventional wheels. Magnetic levitation technology has the potential to exceed 6.4 thousand km/h (4,000 mph) if performed in a vacuum tunnel. When is not used vacuum tunnel, the energy required for levitation not usually represents a large part of the necessary, since most of the energy is used to overcome air resistance, as well as with any other train.

The largest recorded speed of a Maglev train was 581 km/h (361 mph), achieved in Japan in 2003, 6 km/h faster than the speed record for conventional TGV. This speed is lower than a plane, but should be taken into mind that the aircraft can fly at much greater altitudes, where the air resistance is lower, and therefore, high speeds are easier to reach.

The absence of physical contact between the rail and carriages, means that the only friction is with air, and this is minimized by its aerodynamic shape. Maglev trains can travel at very high speeds, with high energy consumption to maintain and control the polarity of the magnets and low noise level (an advantage over competing system called air train), being able to reach up to 650 km/h, but the maximum tested in this train is 584 km/h. These higher speeds make the Maglev may eventually become direct competitors of air transport.

### PRIOR ART

In regard to prior art, we can cite patent ES 2 040 170, which refers to a kinetic energy storage system of electric energy, and using linear electrical machines by magnetic or electrodynamic levitation support, characterized because the energy power is stored as kinetic energy into a rotating mass that spins at high speed in a toroidal enclosure in which the vacuum is made and sustained by magnetic forces, electrodynamic a combination of these, the storage is reversible, performing double conversion, electricity in kinetic energy and kinetic energy into electrical energy by an electric linear (quasi-linear).

One of the aims of the invention is generate electricity by using the force produced by the rotary motion into entertainment games carriages, propelled by the use of inertia or gravity and using the magnetic levitation system, which can increase the speed of transport, greater security in the derailment and low noise, the only limitation is air resistance.

To better understand the invention of the system to generate electricity through magnetic levitation and inertia, with dips and rises as an example in railway carriages in entertaining games or similaris it will describe regarding the drawings which form an integral part, which has character only illustrative and not limiting the invention to this example, wherein:

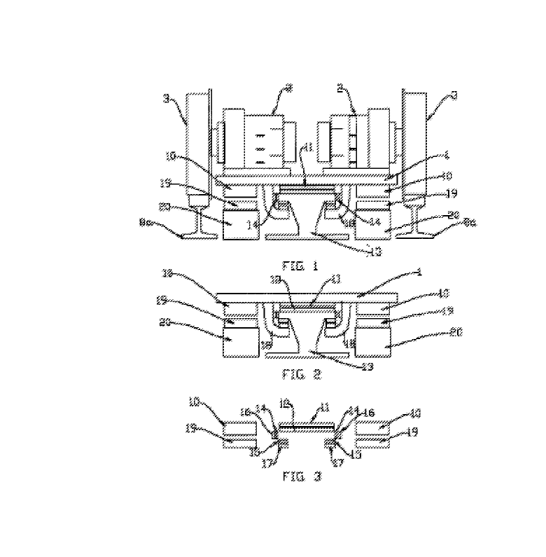

FIG. 1 shows a front view of the railway with the system to generate electricity, using magnetic levitation.

FIG. 2 shows a front view of the central guide rail, the lower base, the provision of a magnetized bars for propulsion by levitation.

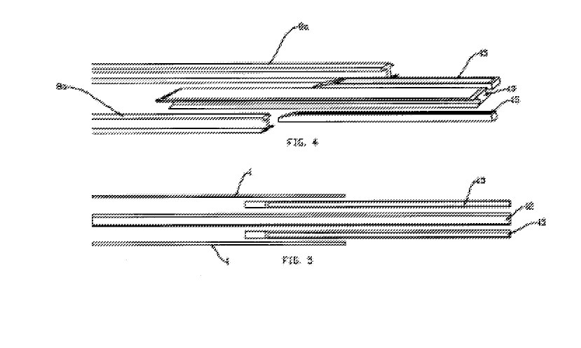

FIG. 3 shows a front view of the magnetized bars, to produce carriage levitation generation.

FIG. 4 shows a upper perspective view of the rails with magnets, for magnetic levitation.

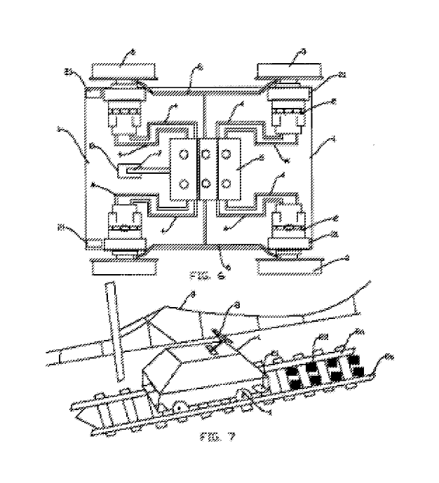

FIG. 5 shows a upper plan view of FIG. 3.

FIG. 6 shows an upper view of the carriage with the generators and the current transformer and pantograph to enable current distribution generated.

FIG. 7 shows a perspective view of the rail structure, the power generation carriage adapted to an entertainment game with inertial propulsion with distribution pantograph to high voltage wires.

### DESCRIPTION OF THE INVENTION

According to FIGS. 1 to 7, the invention for generating electrical power systemproduced by the inertial force of the movement in carts (1) rail or similar (1), by using magnetic levitation.

The carriages (1) are equipped with some alternators (single or three phase) (2), which generates current by using the power of the rotational movement of the shafts connected to the transmission system of each of the wheels (3), said alternators (2) generates electric current, which is driven by voltage lines (4) to a transformer (5) grounding provided (6), with charcoal located in the wheels (3) as a safety means. The current generated at the transformer (5) is driven by a to high voltage line (7) to a pantograph (8), which allows generated current to high tension wires (9) or stored in batteries for further use.

Inertial generator system with magnetic levitation, is formed with magnetized longitudinal bars (10) which are arranged on the lower side and sideways perimeter of the lower base of the carriage (1), as well as longitudinal bars magnetized upper (11) and lower (12) similar both, the upper one located in the _{—} central bottom of said carriage (1) and the lower located in the upper floor of a central guide rail (13), also, said levitation system is provided with magnetized bars, (14) and (15), which are located in the lateral edges top and at the bottom of said upper perimeter protruding, from said central guide rail (13), being the latter magnetized bars, less wide than the others, which also face to other additional magnetized bars, of equal configuration (16) and (17), which are fixed inside hooks configuration “L” (18) in carriage lower base (1).

Levitation system also presents a lower longitudinal bars magnetized (19), similar to lateral magnetized bars, (10), which are arranged on longitudinal metal rails (20), which are fixed on the floor rail or ramp structure, and also arranged to the sides of railroad tracks (8a) and front side to these magnetized bars, (10).

At the apexes of the area or bottom base of the carriage (1) and induced means, presents superconducting coils (21) and as a inductor means , are located on the floor of the railroad, a three-phase shorted circuit coils or plates of metal (22), which allows to maintain constant moving for said carriage (1) games for entertainment or similar.

1. System for generating electric current, produced by the force of inertial movement in cars (1) rail or similar (1) by using magnetic levitation, CHARACTERIZED because said carriages (1) are provided with some alternators (single or three phase) (2), which generates current by using the power of the rotational movement of the shafts connected to the transmission system of each of the wheels (3), said alternators (2) generates the electric current, which is conducted by lines tension (4) to a transformer (5) grounding provided (6), with charcoal located in the wheels (3) as a means of security; the current generated to the transformer (5) is driven by a line of high tension (7) to a pantograph (8), which allows to deliver the generated current to high voltage cables (9) or stored in batteries for further use.

2. System for generating electric current according to claim 1, CHARACTERIZED because the inertial system generator, with magnetic levitation, is formed with magnetized longitudinal bars (10), which are arranged at the bottom and toward the lateral sides of the perimeter lower base of the carriage (1), as well as superior magnetized longitudinal bars (11) and bottom (12) two similar, situated in the upper central area of said bottom carriage (1) and the lower located in the lower floor of one central guide rail (13), Furthermore said levitation system is provided with magnetized bars (14) and (15), which are located in the upper and side edges at the bottom of said peripheral protrusions upper center, of the guide rail (13), the latter being magnetized bars, less wide than the others, which also face additional magnetized bars in the same configuration (16) and (17), which are fixed inside hooks configuration “L” (18) having the lower base of the carriage (1).

3. System for generating electrical power according to claims 1 and 2 CHARACTERIZED because levitation system also presents a lower longitudinal bars magnetized (19), similar to the side magnetized bars (10), which are arranged on longitudinal rails metal (20), which are fixed on the floor of the railway structure or ramp and disposed also to the sides of railroad tracks (8a) and front side to said magnetized bars (10).

4. System for generating electric current, according to claim 1 CHARACTERIZED because the apexes of the area or bottom base of carriage (1) as induced means, presents superconducting coils (21) and as inducing medium is placed on the floor of the railroad, three phase coils short circuited or a metal plate (22), which allows to maintain constant moving for said carriage (1) games for entertainment or similar.
